(19) United States
(12) Patent Application Publication
(10) Pub. No.: US 2007/0292725 A1
(43) Pub. Date: Dec. 20, 2007

(54) Fuel Cell Assembly With Operating Temperatures For Extended Life

(76) Inventors: Richard D. Breault, North Kingstown, RI (US); Carl Rohrbach JR., Somers, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/718,258

(22) PCT Filed: Dec. 29, 2004
(86) PCT No.: PCT/US04/44008

§ 371 Date: Apr. 30, 2007

(51) Int. Cl. H01M 8/00; H01M 8/04; H01M 8/12

(52) U.S. Cl. 429/13; 429/12; 429/33

(57) ABSTRACT

A fuel cell assembly (20) includes an electrochemically active portion (40) that operates at an average operating temperature within a temperature range that is selected based upon an expected life cycle of the fuel cell assembly (20). In a disclosed example, the average operating temperature range for the electrochemically active portion is between about 340° F. (171° C.) and about 360° F. (182° C.). Maximum and minimum operating temperatures of the electrochemically active portion may be outside of the average operating temperature range. In one example, the electrochemically active portion is maintained at a temperature of at least 300° F. (149° C.) and less than 400° F. (204° C.).

### 1. FIELD OF THE INVENTION

This invention generally relates to fuel cells. More particularly, this invention relates to operating a fuel cell at temperatures for realizing extended fuel cell life.

### 2. DESCRIPTION OF THE RELATED ART

Fuel cells are well known and are finding increasing usage for a variety of applications. One type of fuel cell is known as a phosphoric acid fuel cell (PAFC) and is used for stationary power generation, for example. One shortcoming of known PAFCs is that the cell stack assemblies usually need to be replaced about every five years. After that time, the performance of the assembly degrades to a level that is below a useful or acceptable level for most applications. The loss of performance typically results from portions of the catalyst layer being flooded with electrolyte. The combined effects over time of electrode potential and operating temperatures in the cell stack assembly result in oxidation of a surface of a carboneaous catalyst support, which results in the performance-degrading flooding.

It is desirable to provide an improved fuel cell arrangement that does not require replacement of a cell stack assembly as often as with known arrangements. This invention addresses that need.

### SUMMARY OF THE INVENTION

An example fuel cell assembly that operates in accordance with an embodiment of this invention includes an electrochemically active portion that operates at an average temperature within a range between about 340° F. (171° C.) and about 360° F. (182° C.) for an entire useful life of the assembly. In one example, utilizing an average operating temperature within such a range essentially doubles the useful life of the fuel cell assembly compared to arrangements that rely upon traditional operating temperature ranges.

An example method of operating fuel cell assembly includes determining a relationship between a temperature of an electrochemically active portion of the assembly and performance over time. Based upon the determined relationship, selecting an average operating temperature achieves a desired minimum performance for a desired minimum amount of time.

In one example, the average operating temperature range is between about 340° F. (171° C.) and about 360° F. (182° C.).

One example includes selecting a minimum operating temperature that is below a lowest temperature in the average operating temperature range. In one example, the minimum operating temperature is about 300° F. (149° C.). Another example includes selecting a maximum operating temperature for the electrochemically active portion of the fuel cell assembly that exceeds a highest temperature within the average operating temperature range. In one example, the maximum temperature is about 390° F. (199° C.).

The various features and advantages of this invention will become apparent to those skilled in the art from the following detailed description of a currently preferred embodiment. The drawings that accompany the detailed description can be briefly described as follows.

### BRIEF DESCRIPTION OF THE DRAWINGS

FIG. 1 schematically shows a fuel cell assembly.

FIG. 2 is a graphical representation of a relationship between temperature and fuel cell performance over time.

FIG. 3 is a graphical representation of example relationships between fuel cell operation and time.

### DETAILED DESCRIPTION OF THE PREFERRED EMBODIMENTS

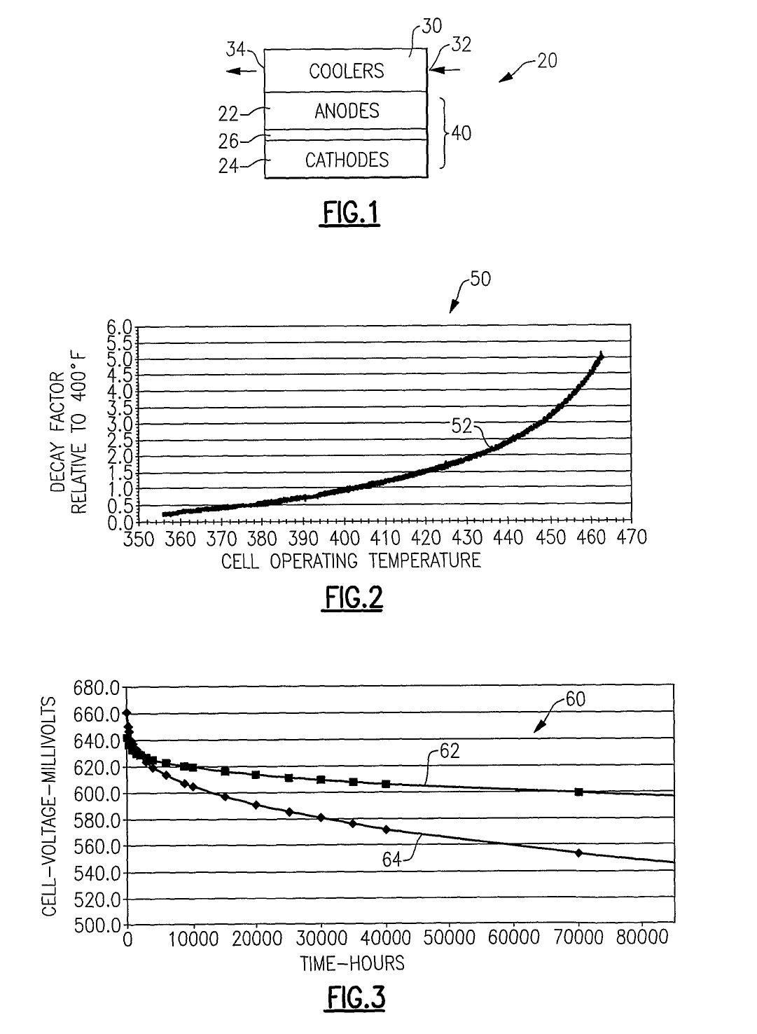

FIG. 1 schematically shows a fuel cell assembly 20. A cell stack assembly includes a plurality of anodes 22 and cathodes 24 on opposite sides of an electrolyte portion 26. These operate in a known manner. In one example, the electrolyte portion 26 includes phosphoric acid and the assembly is known as a phosphoric acid fuel cell assembly.

The illustrated example also includes coolers 30 that operate in a known manner by having coolant enter an inlet 32 and exit an outlet 34 as known.

It is known that fuel cell assemblies have various temperatures at various locations within the assembly. For purposes of discussion, the electrochemically active areas where there is overlap between the catalysts in a cathode 24 and an anode 22 are referred to as the electrochemically active portion 40 of the fuel cell assembly 20. It is also known that temperature may vary within the electrochemically active portion because there are variations in local current density and because of the configuration of the coolers 30. For example, there are temperature gradients in a direction of coolant flow within a cell stack, and in an axial direction because of the typical number of cells between each cooler and the direction of heat flow from the cells to the coolers. Temperatures. within the assembly also change as power demands from the cells change.

One feature of fuel cell assemblies is that the operating temperature of the electrochemically active portion has a direct impact on the useful life of the assembly. FIG. 2, for example, shows a plot 50 of a decay factor relative to 400° F. (204° C.) versus operating temperature. The curve 52 shows one example relationship between the decay in cell performance and temperature. As can be appreciated from FIG. 2, elevated temperatures correspond to escalated decay rates, which in turn correspond to shorter useful fuel cell life spans. According to an example implementation of this invention, the relationship between temperature and performance over time is used as a decision factor when selecting an operating temperature range for the fuel cell assembly.

With the traditional approach, the operating conditions of a phosphoric acid fuel cell power plant were selected to reach maximum initial performance and initial power plant efficiency. Taking this approach requires operating temperatures that are set based on limitations of the materials within the cell stack assembly. This approach does not take into account the performance degradation as a decision factor when selecting the operating temperatures for the electrochemically active portion 40. Accordingly, the example approach disclosed for the first time in this description is based upon decision factors not used in the traditional approach.

An example fuel cell assembly designed according to an embodiment of this invention includes an average operating temperature range for the electrochemically active portion 40 that is selected to achieve at least a minimum level of performance (i.e., available power output) for at least a selected amount of time. One example includes an average operating temperature of the electrochemically active portion 40 that is within a range between about 340° F. (171° C.) and about 360° F. (182° C.). This average operating temperature range is considered the average over the useful lifetime of the fuel cell assembly. Of course, there will be some variations in operating temperature for known reasons.

A maximum operating temperature for the electrochemically active portion 40, which is outside of the average operating temperature range, in one example, is maintained between about 380° F. (193° C.) and about 400° F. (204° C.). Maintaining the maximum temperature at or below a temperature within this range reduces performance decay, which is directly related to elevated temperatures in a fuel cell assembly. In one preferred example, the maximum operating temperature for the electrochemically active portion 40 is 390° F. (199° C.). This maximum operating temperature will most likely occur in the cells near a center of a stack of cells between coolers.

In one example, the absolute minimum temperature of the electrochemically active portion under operating conditions is maintained at a temperature of at least 300° F. (149° C.). Maintaining a minimum temperature of at least 300° F. (149° C.) is preferred to minimize poisoning the anode catalyst with the carbon monoxide present in reformed fuel.

Non-electrochemically active portions of the fuel cell assembly that are not part of the electrochemically active portion 40, such as acid condensation zones that operate in a known manner, may operate at lower temperatures. Acceptable ranges for the non-electrochemically active portions of the fuel cell assembly may be different than those used for the electrochemically active portion and may be selected to meet the needs of a particular situation.

For example, the coolant inlet 32 in one example has an operating temperature of approximately 270° F. (132° C.) and the coolant outlet 34 has an associated temperature of about 337° F. (169° C.). These example temperatures correspond to an average electrochemically active portion operating temperature of 350° F. (177° C.) and a maximum temperature of the electrochemically active portion 40 of 390° F. (199° C.).

Known phosphoric acid fuel cells operate at reactant pressures between approximately ambient pressure and approximately ten atmospheres. It is known that decay rates increase as pressures increase. This is the result of oxidation of the carboneaous catalyst supports that become more wettable at higher pressures. In one example fuel cell assembly designed according to an embodiment of this invention, the preferred operating pressure is approximately ambient (i.e., between about 14.7 and 20 psia).

In some examples, selecting an average operating temperature range for the electrochemically active portion based upon the relationship between performance and time will provide somewhat lower voltage output and lower efficiency at the beginning of the fuel cell life compared to fuel cells utilizing the traditional approach for selecting operating temperatures. With the inventive approach, however, the average voltage and efficiency exceeds that of cells operating at higher temperatures. Additionally, with the inventive approach, a fuel cell is able to provide such improved output for an extended lifecycle. In one example, the useful life of the fuel cell assembly is doubled compared to a similarly configured assembly using traditional temperature ranges.

FIG. 3 includes a plot 60 of voltage per cell over time. A first curve 62 shows one example relationship for a fuel cell assembly utilizing an average operating temperature range corresponding to the example described above. The curve 64 shows a correspondingly configured fuel cell assembly using a traditional, higher temperature operating range. Although the curve 64 includes a higher voltage output at the beginning of the fuel cell life cycle, the increased decay rate shows how the fuel cell using an operating temperature range according to this invention soon produces more power at a higher efficiency and does so for a much longer useful time. In the illustrated example, there is some sacrifice of initial performance and efficiency, but that is considered to be outweighed by the slower performance decay rate and the overall average increase in power, which results in a lower life cycle cost and a lower cost of electricity produced by the fuel cell assembly. Although described in the context of a PAFC, this invention may be applied to other fuel cells such as a high temperature polymer electrolyte fuel cells.

Given this description, those skilled in the art will be able to select appropriate temperature values to best meet the needs of their particular situation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method of operating a fuel cell assembly, comprising the steps of:
determining a relationship between a temperature of an electrochemically active portion of the assembly and performance over time; and
selecting an average operating temperature range based on the determined relationship to achieve at least a desired minimum performance for at least a desired minimum amount of time.

2. The method of claim 1, wherein the average operating temperature range is between about 340° F. (171° C.) and about 360° F. (182° C.).

3. The method of claim 1, including selecting a minimum operating temperature that is below a lowest temperature in the average operating temperature range and a maximum operating temperature that is above a highest temperature in the average operating temperature range.

4. The method of claim 3, wherein the average operating temperature range is between about 340° F. (171° C.) and about 360° F. (182° C.), the minimum operating temperature is about 300° F. (149° C.) and the maximum operating temperature is less than about 400° F. (204° C.).

5. The method of claim 4, wherein the maximum operating temperature is about 390° F. (199° C.).

6. The method of claim 1, including operating the fuel cell assembly at a pressure that is approximately ambient.

7. The method of claim 1, wherein the fuel cell is a phosphoric acid fuel cell.

8. The method of claim 1, wherein the fuel cell is a high temperature polymer electrolyte fuel cell.

9. A method of operating a fuel cell assembly, comprising:
operating an electrochemically active portion of the fuel cell assembly within an average operating temperature range between about 340° F. (171° C.) and about 360° F. (182° C.) for an entire useful life of the assembly.

10. The method of claim 9, including maintaining a minimum temperature of the electrochemically active portion at a temperature that is at least about 300° F. (149° C.).

11. The method of claim 9, including maintaining a maximum temperature of the electrochemically active portion at a temperature less than about 400° F. (204° C.).

12. The method of claim 9, including using a maximum temperature of the electrochemically active portion of about 390° F. (199° C.).

13. The method of claim 9, including operating the fuel cell assembly at a pressure that is approximately ambient.

14. The method of claim 9, wherein the fuel cell is a phosphoric acid fuel cell.

15. The method of claim 9, wherein the fuel cell is a high temperature polymer electrolyte fuel cell.

16. A fuel cell assembly, comprising:
an electrochemically active portion that operates an average temperature within a range between about 340° F. (171° C.) and about 360° F. (182° C.) for an entire useful life of the assembly.

17. The fuel cell assembly of claim 16, wherein the assembly operates at a pressure that is approximately ambient.

18. The fuel cell assembly of claim 16, wherein the electrochemically active portion has a minimum temperature above about 300° F. (149° C.).

19. The fuel cell assembly of claim 18, wherein the electrochemically active portion has a maximum temperature that is less than about 400° F. (204° C.).

20. The fuel cell assembly of claim 19, wherein the maximum temperature is approximately 390° F. (199° C.).

21. The fuel cell assembly of claim 16, including a coolant inlet that has an associated temperature of about 270° F. (132° C.) and a coolant exit that has an associated temperature of about 337° F. (169° C.).

22. The fuel cell assembly of claim 16, comprising a phosphoric acid fuel cell.

23. The fuel cell assembly of claim 16, comprising a high temperature polymer electrolyte fuel cell.

24. The method of claim 1, wherein the average operating temperature range is used for normal operation of the fuel cell assembly.

25. The method of claim 1, wherein the determined relationship includes a period of time that is at least as long as an expected useful life of the fuel cell assembly.

26. The method of claim 1, comprising using the selected average operating temperature range for normal fuel cell assembly operation over an entire useful lifetime of the fuel cell assembly.

27. The method of claim 9, comprising using the average operating temperature range for normal fuel cell assembly operation.

28. The fuel cell assembly of claim 16, wherein the electrochemically active portion operates under normal conditions at the average temperature.
